(19) United States
(12) Patent Application Publication
(10) Pub. No.: US 2006/0050295 A1
(43) Pub. Date: Mar. 9, 2006

(54) Switchable printer or output servo device

(76) Inventors: Yi-Ming Chin, Taipei Hsien (TW); Hao-Che Hsieh, Taipei Hsien (TW); Jeng-Chen Lu, Taipei Hsien (TW); Tsung Ju Yu, Taipei Hsien (TW); Jaw Shian Chen, Taipei Hsien (TW)

Correspondence Address: CHARLES E. BAXLEY, ESQ., 90 JOHN STREET, THIRD FLOOR, NEW YORK, NY, 10038, US

(21) Appl. No.: 10/936,327

(22) Filed: Sep. 8, 2004

(51) Int. Cl. G06F 3/12

(52) U.S. Cl. 358/1.15

(57) ABSTRACT

A printer servo device includes a main servo device, two communicating devices coupled to the main servo device, and an output device coupled to the main servo device. The main servo device includes a judging device to determine whether either of the communicating devices is coupled to the output device or not, and includes a switching device to selectively couple either of the communicating devices to the output device, and to allow requests from the communicating devices to be automatically outputted from the output device. The main servo device includes an output port coupled between the output device and the communicating devices.

### BACKGROUND OF THE INVENTION

1. Field of the Invention

The present invention relates to a printer or output servo device, and more particularly to a switchable printer or output servo device for allowing two or more users to be selectively switched or coupled to a printer or an output device automatically.

2. Description of the Prior Art

Terminals or other computer facilities have been widely used for working purposes today, and many companies, factories, organizations, or the like may each required to purchase a number of terminals or other computer facilities, and one or more printers or output facilities coupled to the terminals or other computer facilities, for data or information outputting purposes.

Normally, most of the companies, factories, organizations, or the like may purchase fewer printers or output facilities, each of which may be coupled to two or more terminals or other computer facilities, via such as a network sharing device, for allowing many terminals or other computer facilities to share the printers or output facilities. A typical printer servo device have thus been developed for coupling between the printers or output facilities and the terminals or other computer facilities.

For example, as shown in FIG. 5, illustrated is one of the typical printer servo devices 10 for coupling a printer output device 30 to a network sharing device 20, for allowing many terminals or other computer facilities or end users 22, 23, 24 to share the printer or output facility 30.

The typical printer servo devices 10 may be used to couple the printer output devices 30 to the network sharing devices 20 only. However, in the companies, factories, organizations, or the like, a lot of other output devices may also be required for working purposes, such as photocopy machines, scanner devices, facsimile machines, or the like. However, the typical printer servo devices 10 may not be used to couple the network sharing devices 20 to the other output devices.

The present invention has arisen to mitigate and/or obviate the afore-described disadvantages of the conventional printer servo devices.

### SUMMARY OF THE INVENTION

The primary objective of the present invention is to provide a printer servo device for allowing two or more end users to be selectively switched or coupled to a printer or an output device automatically.

In accordance with one aspect of the invention, there is provided a printer servo device comprising a main servo device, a first communicating device coupled to the main servo device, a second communicating device coupled to the main servo device, and an output device coupled to the main servo device. The main servo device includes a judging device to determine whether the first communicating device or the second communicating device is coupled to the output device or not, and includes a switching device to selectively couple the first communicating device and the second communicating device to the output device, and to allow requests from the first communicating device and the second communicating device to be suitably outputted from the output device.

The judging device of the main servo device is coupled to the first communicating device. The first communicating device is provided for allowing end users to coupled to the main servo device via the first communicating device.

The main servo device includes an output port coupled to the output device and coupled to the switching device. The main servo device includes a coupler coupled between the second communicating device and the output port. The switching device and the judging device of the main servo device are preferably coupled together.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram illustrating a printer servo device in accordance with the present invention for coupling two or more end users to an output device;

FIG. 2 is another block diagram of the printer servo device;

FIG. 3 is a flow chart illustrating the operation of the printer servo device for selectively coupling one of the end users to the output device;

FIG. 4 is another flow chart illustrating the operation of the printer servo device for selectively coupling another end user to the output device; and

FIG. 5 is a block diagram illustrating a typical printer servo device.

### DETAILED DESCRIPTION OF THE PREFERRED EMBODIMENT

Referring to the drawings, and initially to FIG. 1, a printer servo device in accordance with the present invention comprises a main servo device 10, and one or more end users 22, 23, 24, or a communicating device or network sharing device 20 and another communicating device or terminal device 31 coupled to the main servo device 10.

For example, the end users 22, 23, 24 may be coupled to the network sharing device 20 for message or information sharing purposes. The terminal device 31 may be any suitable terminal facilities, persona computers, or other computer facilities for input message or information or signals into the main servo device 10, or for controlling the main servo device 10.

The main servo device 10 is coupled to an output device 30, such as a printer, a photocopy machine, a scanner device, a facsimile machine, or the like, and is provided for selectively coupling either of the end users 22-24 or the network sharing device 20 or the terminal device 31 to the output device 30, and thus for allowing two or more end users 22-24 or the network sharing device 20 or the terminal device 31 to be selectively switched or coupled to the printer or output device 30 automatically.

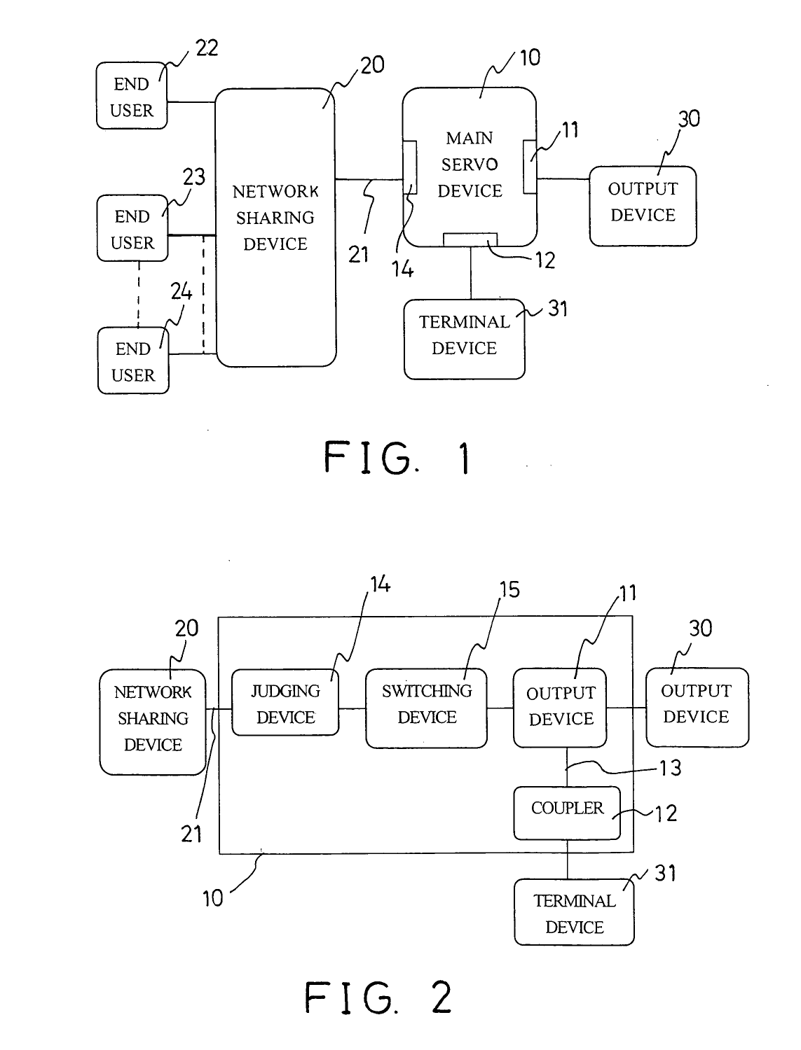

Referring next to FIG. 2, illustrated is another block diagram of the main servo device 10 of the printer servo device. The main servo device 10 includes an output port 11 coupled to the output device 30, a coupler 12 coupled to the output port 11 via a cable or a passage 13 and coupled to the terminal device 31, a judging device 14 coupled to the network sharing device 20 via a cable or another passage 21, and a switching device 15 coupled between the judging device 14 and the output port 11.

The cables or passages 13, 21 and/or the switching device 15 may be selected from any suitable couplers, such as universal serial bus (USB) couplers, institute of electrical and electronic engineers (IEEE) couplers, or the like, for allowing message or information or signals to be suitably coupled or communicated between the main servo device 10 and the end users 22-24 or the network sharing device 20 and the terminal device 31 and the output device 30.

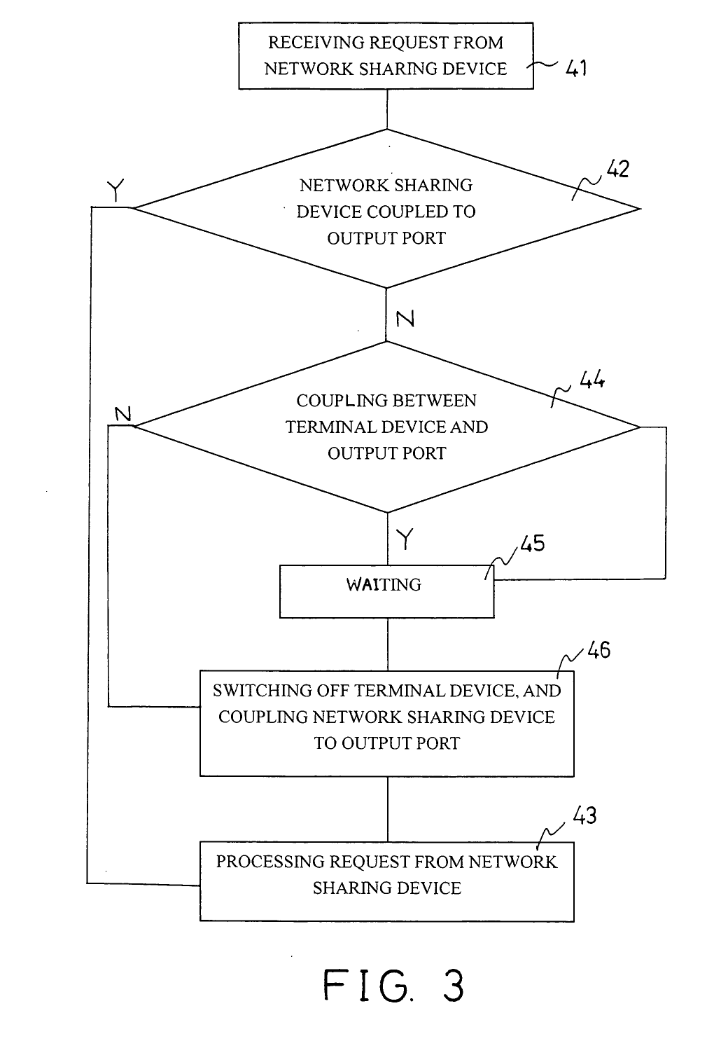

In operation, as shown in FIG. 3, when a printing or output request is sent from the network sharing device 20 to the main servo device 10, or when the main servo device 10 receives a printing or output request from the network sharing device 20 in process 41, the judging device 14 will judge or determine whether the network sharing device 20 is coupled to or communicating with the main servo device 10 or not in process 42.

When the network sharing device 20 has been judged or determined or detected to be coupled to or communicating with the main servo device 10, the switching device 15 may couple the output port 11 to the output device 30, to allow the request from the network sharing device 20 to be treated or processed or operated or outputted with the output device 30 in process 43.

On the contrary, when the network sharing device 20 has been judged or determined or detected not to be communicating with or to be coupled to the main servo device 10, a process 44 may be provided and used to judge or to determine or to detect whether the terminal device 31 is communicating with or is coupled to the output device 30 or not.

If the terminal device 31 has been judged or determined or detected to be coupled to or communicating with the output device 30, then a waiting process 45 may be provided and used to wait until the message or information or signals from the terminal device 31 have been suitably or completely treated or processed or operated or outputted with the output device 30.

On the contrary, if the terminal device 31 has been judged or determined or detected not to be coupled to or communicating with the output device 30, the switching device 15 may then cut off or switch off the coupling between the terminal device 31 and the output device 30, and may then couple the network sharing device 20 to the output device 30 in process 46, to allow the request from the network sharing device 20 to be treated or processed or operated or outputted with the output device 30.

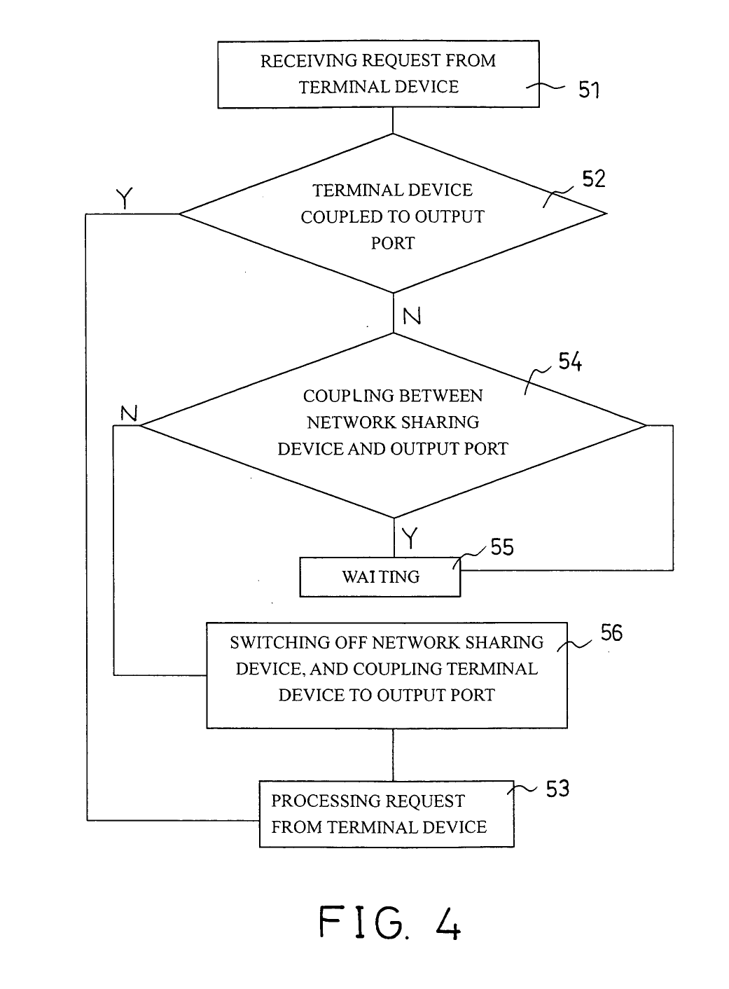

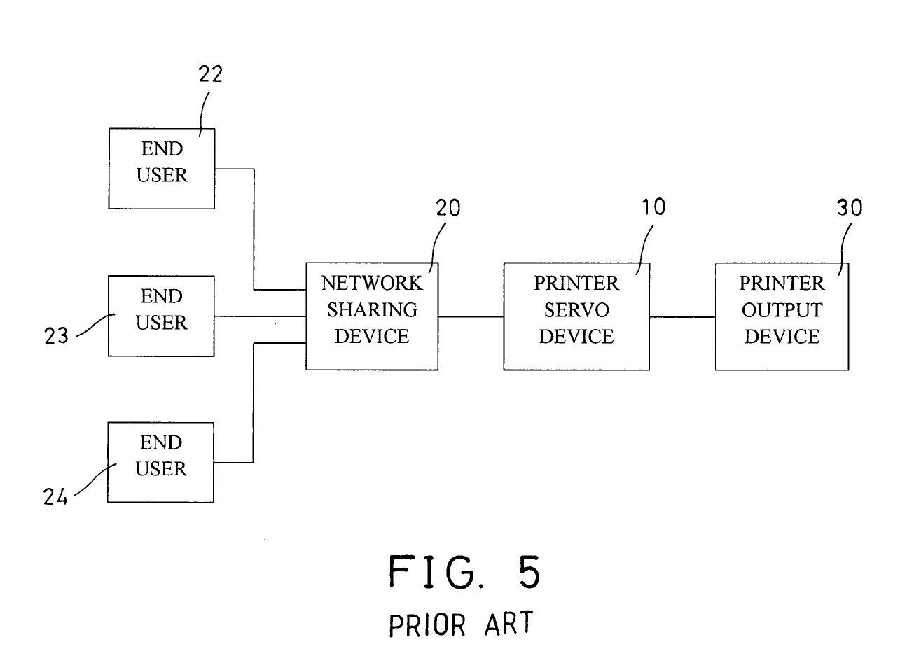

Alternatively, as shown in FIG. 4, when a printing or output request is sent from the terminal device 31 to the main servo device 10, or when the main servo device 10 receives a printing or output request from the terminal device 31 in process 51, the judging device 14 will judge or determine whether the terminal device 31 is coupled to or communicating with the main servo device 10 or not in process 52.

When the terminal device 31 has been judged or determined or detected to be coupled to or communicating with the main servo device 10, the switching device 15 may couple the output port 11 to the output device 30, to allow the request from the terminal device 31 to be treated or processed or operated or outputted with the output device 30 in process 53.

On the contrary, when the terminal device 31 has been judged or determined or detected not to be communicating with or to be coupled to the main servo device 10, a process 54 may be provided and used to judge or to determine or to detect whether the network sharing device 20 is communicating with or is coupled to the output device 30 or not.

If the network sharing device 20 has been judged or determined or detected to be coupled to or communicating with the output device 30, then a waiting process 55 may be provided and used to wait until the message or information or signals from the network sharing device 20 have been suitably or completely treated or processed or operated or outputted with the output device 30.

On the contrary, if the network sharing device 20 has been judged or determined or detected not to be coupled to or communicating with the output device 30, the switching device 15 may then cut off or switch off the coupling between the network sharing device 20 and the output device 30, and may then couple the terminal device 31 to the output device 30 in process 56, to allow the request from the terminal device 31 to be treated or processed or operated or outputted with the output device 30.

Either of the end users 22-24 from the network sharing device 20 and the terminal device 31 may thus be selectively and automatically coupled to the output device 30 by the judging device 14 and the switching device 15 of the main servo device 10, to allow the requests or the message or information or signals from either of the end users 22-24 or from the terminal device 31 to be suitably or completely treated or processed or operated or outputted with the output device 30 automatically.

Accordingly, the printer servo device in accordance with the present invention may be used for allowing two or more end users to be selectively switched or coupled to a printer or an output device automatically.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A printer servo device comprising:
a main servo device,
a first communicating device coupled to said main servo device,
a second communicating device coupled to said main servo device,
an output device coupled to said main servo device, and
said main servo device including a judging device to determine whether said first communicating device or said second communicating device is coupled to said output device or not, and including a switching device to selectively couple said first communicating device and said second communicating device to said output device, and to allow requests from said first communicating device and said second communicating device to be suitably outputted from said output device.

2. The printer servo device as claimed in claim 1, wherein said judging device of said main servo device is coupled to said first communicating device.

3. The printer servo device as claimed in claim 1, wherein said first communicating device is provided for allowing end users to coupled to said main servo device via said first communicating device.

4. The printer servo device as claimed in claim 1, wherein said main servo device includes an output port coupled to said output device and coupled to said switching device.

5. The printer servo device as claimed in claim 4, wherein said main servo device includes a coupler coupled between said second communicating device and said output port.

6. The printer servo device as claimed in claim 1, wherein said switching device and said judging device of said main servo device are coupled together.
